(19) United States
(12) Patent Application Publication
(10) Pub. No.: US 2026/0055009 A1
(43) Pub. Date: Feb. 26, 2026

(54) SYSTEM AND METHOD FOR TREATING WASTEWATER FROM AN OILFIELD WELL WITH CO-PRODUCTION OF POWER

(71) Applicant: NUOVO PIGNONE TECNOLOGIE - S.R.L., Florence (IT)

(72) Inventors: Brian REEVES, Florence (IT); Jose Adrian CHAVEZ VELASCO, Florence (IT)

(21) Appl. No.: 19/106,526

(22) PCT Filed: Aug. 28, 2023
(86) PCT No.: PCT/EP2023/025389

§ 371 Date: Feb. 25, 2025

(30) Foreign Application Priority Data
Sep. 2, 2022 (IT) 102022000018072
Jul. 28, 2023 (IT) 102023000015984

(51) Int. Cl. C02F 1/04; B01D 1/00; C02F 1/16; C02F 103/10; E21B 43/34; F01K 11/02; F02C 6/18; F22B 1/18; F22D 1/50; F23R 3/28

(52) U.S. Cl. CPC C02F 1/048; B01D 1/0058; C02F 1/16; E21B 43/34; F01K 11/02; F02C 6/18; F22B 1/1815; F22D 1/50; F23R 3/28; C02F 2103/10; C02F 2303/10; F05D 2220/72; F05D 2220/76

(57) ABSTRACT

The wastewater treatment system comprising a combustor adapted to burn a fuel and generate pressurized combustion gas therewith. The system also includes gas turbine adapted to expand the pressurized combustion gas and generate mechanical power therewith. The system further includes a boiler adapted to receive expanded combustion gas from the gas turbine. The boiler is fluidly coupled to a wastewater line. In use, heat from the combustion gas generates steam from the wastewater and a brine is removed from the boiler through a brine discharge line. In some embodiments a steam cycle is also provided in the system to extract further power.

### TECHNICAL FIELD

The present disclosure relates to wastewater treatment. More specifically, the present disclosure concerns systems and methods for treating wastewater from oilfield wells.

### BACKGROUND ART

Pumping oil and gas out of the ground also produces large volumes of water containing polluting or undesired chemical substances. This wastewater is also known as produced water. The amount of produced water vs. oil extracted from an oilfield well can vary over time and from one oilfield to another. The nature of suspended or dissolved solids and chemicals contained in the produced water can vary from well to well and over time.

The highly saline produced water is considered an industrial waste and shall be safely disposed of in an environmentally acceptable manner. One way to dispose of produced water is to transport the water to a reservoir, usually an underground reservoir, and dispose of the water in the reservoir. Another way is to re-inject the produced water in the oilfield well.

Large amount of power is needed to transport and/or re-inject produced water in an underground reservoir. Attempts have been made to address this problem and reduce the amount of power needed. One way of reducing the amount of power required to transport or pump produced water is to reduce the volume of produced water to be treated.

In order to reduce the volume of produced water to be disposed of, it has been suggested to evaporate part of the water, for instance using a boiler. Steam generated by partial evaporation of wastewater is devoid of contaminants and polluting agents and can be simply released in the atmosphere.

Natural gas from the oilfield well can be used to heat the boiler and generate steam, which is discharged in the environment, thus leaving concentrated produced water (brine), which is finally disposed of.

These known methods and systems for reducing the amount of wastewater are not efficient from an energy point of view. Moreover, vaporizing water containing high concentrations of chemicals may result in early scaling or fouling of the boiler.

More efficient systems and methods for treating wastewater from oilfield wells would therefore be welcomed in the art.

### SUMMARY

According to a first aspect, disclosed herein is a wastewater treatment system, which includes a combustor adapted to burn a fuel and generate pressurized combustion gas therewith. The system further includes a gas turbine adapted to expand the pressurized combustion gas and generate mechanical power therewith. The system also includes a boiler adapted to receive expanded combustion gas from the gas turbine and which is fluidly coupled to a wastewater line. In use, low-temperature heat from the combustion gas (flue gas) expanded in the gas turbine generates steam from the wastewater by heat exchange in the boiler. Part of the water is evaporated and released in the atmosphere, thus reducing the volume of wastewater to be disposed of. The remaining wastewater is a brine containing a concentrated amount of chemicals and is discharged through a discharge line from the boiler and disposed of.

The term “boiler” as understood herein includes any device adapted to transfer heat from the expanded combustion gas to the wastewater and evaporate at least part of the wastewater. The boiler can be an evaporator.

The option is not excluded, to fully evaporate water and obtain salts and solids as a final product, which is then disposed of.

The system improves the overall energy efficiency by extracting mechanical power from the expansion of the combustion gas before the latter is used to evaporate wastewater.

In preferred embodiments, the combustor is adapted to receive natural gas from the oilfield well. The natural gas from the oilfield well is thus used for power generation and concentration of wastewater, rather than flared, which further increases the overall energy efficiency of the system. If natural gas from the oilfield well is insufficient or not available, an additional source of fuel can be provided in combination.

In some instances, gas from the oilfield well can be partly delivered to a pipeline and/or to a natural gas liquefaction unit and partly to the gas turbine.

Natural gas from the oilfield well can be pre-treated before use in the gas turbine, for instance to remove contaminants and heavier hydrocarbons.

The system further includes a pressure adjusting device, adapted to receive natural gas from the oilfield well and adapt pressure thereof to a combustion pressure in the combustor. As will be described in more detail below, the pressure adjusting device can be designed to increase or to decrease the natural gas pressure, depending upon the pressure at which the natural gas is available at the well and upon the combustor pressure.

The mechanical power generated by the gas turbine can be converted into electric power by an electric generator drivingly coupled to the gas turbine.

According to further embodiments, the system can further include a steam turbine adapted to receive steam from the boiler or evaporator, and expand the steam to generate mechanical power. In some embodiments, the mechanical power generated by the steam turbine can be converted into electric power by a further electric generator drivingly coupled to the steam turbine.

In some embodiments, to further improve the energy efficiency thereof, the system can further include a heat recuperator. The heat recuperator can include a heat exchanger with a hot side and a cold side. The brine discharge line flows through the hot side of the heat exchanger, and the wastewater line flows through the cold side of the heat exchanger, such that heat from the brine is recovered by the wastewater.

According to a further aspect, disclosed herein is a method for treating wastewater from an oilfield well. The method includes the following steps:
generating pressurized combustion gas in a combustor;
expanding the combustion gas in a gas turbine and producing mechanical power therewith;
producing steam and a brine flow from the wastewater by evaporating wastewater using waste heat from the expanded combustion gas.

The step of generating pressurized combustion gas in the combustor includes the step of mixing natural gas from the oilfield well and air and burn a resulting air-gas mixture in the combustor. If needed, additional fuel can be fed to the combustor, if the natural gas from the oilfield well is insufficient.

The method further includes the step of adapting the pressure of the natural gas from the oilfield well to a combustor pressure if so required.

According to some embodiments, the steam generated by partly evaporating the wastewater can be released in the environment as such. In other embodiments, the method can further include the step of expanding the steam in a steam turbine and generating mechanical power therewith prior to releasing the spent steam in the atmosphere.

According to a further aspect, the present disclosure concerns a wastewater treatment system for treating wastewater from an oilfield well, which comprises a combustor adapted to burn a fuel and generate pressurized combustion gas therewith. the system further comprise a gas turbine adapted to expand the pressurized combustion gas and generate mechanical power therewith. A boiler of the system is adapted to receive expanded combustion gas from the gas turbine and fluidly coupled to a wastewater line. In use heat from the combustion gas generates steam from the wastewater. A brine discharge line from the boiler is used to discharge brine and a steam turbine is adapted to receive steam from the boiler, expand said steam to generate mechanical power and release spent steam in the atmosphere.

According to a further aspect, the present disclosure also concerns a method for treating wastewater from an oilfield well, the method comprising the following steps: generating pressurized combustion gas in a combustor; expanding the combustion gas in a gas turbine and producing mechanical power therewith; producing steam and a brine flow from the wastewater by evaporating wastewater using waste heat from the expanded combustion gas; and expanding the steam in a steam turbine and releasing spent steam in the atmosphere.

In some embodiments, the method can further include the step recovering heat from the brine. For instance, the method can include the step of pre-heating the wastewater from the oilfield by heat exchange with the brine discharged from the boiler.

Further features and advantages of the system and of the method disclosed herein are described below with reference to some exemplary embodiments and are further outlined in the attached claims.

### BRIEF DESCRIPTION OF THE DRAWINGS

Reference is now made briefly to the accompanying drawings, in which:

FIG. 1 illustrates a schematic of a first embodiment of a system according to the present disclosure;

FIG. 2 illustrates a schematic of a first embodiment of a further system according to the present disclosure;

FIG. 3 illustrates a schematic of a first embodiment of a further system according to the present disclosure; and

FIGS. 4, 5 and 6 illustrate alternative embodiments of the pressure adjusting unit.

### DETAILED DESCRIPTION

In short, according to embodiments disclosed herein, a gaseous fuel, in particular natural gas, preferably natural gas from an oilfield well, is used to generate compressed combustion gas, which is expanded in a gas turbine, to produce useful power. The exhaust combustion gas is subsequently used as a source of lower-temperature heat to vaporize part of the produced water (wastewater) from the oilfield well and produce a flow of brine, i.e., wastewater with a higher concentration of residual chemicals and other substances, which is finally disposed of. High-temperature thermal power generated by fuel combustion is thus used for the production of mechanical power, while waste heat at a lower temperature is used to evaporate water and produce brine for subsequent disposal. The brine may be formed by a slurry of concentrated evaporated salts and solids.

The overall energy efficiency of the system is improved, since high-temperature thermal energy is used to produce high-quality power (mechanical power).

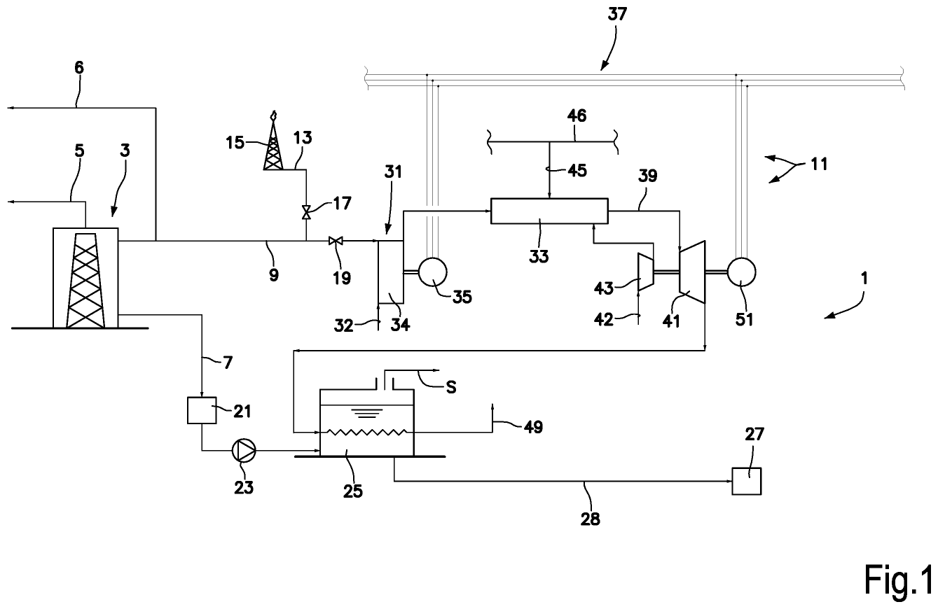

Turning now to the drawings, a first embodiment of a system according to the present disclosure is schematically shown in FIG. 1 and labeled 1 as a whole. An oilfield well is schematically shown at 3. Oil pumped from the oilfield well 3 is delivered through duct 5, while wastewater (produced water) is removed through a wastewater line 7. Natural gas from the oilfield well 3 can be collected in a gas line 9 which is fluidly coupled to a gas turbine sub-system 11 where natural gas can be used to power a gas turbine, as disclosed in greater detail below. A flare 15 can be fluidly coupled to the gas line 9 through a secondary gas line 13. Valves 17, 19 can be used to partly or fully divert the natural gas from the oilfield well 3 towards the flare 15 if needed, for instance if natural gas cannot be processed in the gas turbine sub-system 11, for instance when the sub-system 11 is unavailable due to maintenance or failure, for example.

In some embodiments, the gas line 9 can be fluidly coupled to a further gas line 6, to deliver natural gas to a natural gas liquefaction unit or to a gas pipeline (not shown).

In some embodiments, gas from the oilfield well 3 can be pre-treated in a pre-treatment unit, not shown, to remove impurities or heavy hydrocarbons, which cannot be fed to the combustor of the gas-turbine sub-system 11.

The system 1 further comprises a wastewater pre-treatment unit 21 along the wastewater line 7. A pump 23 can further be provided along the wastewater line 7 if needed. The wastewater pre-treatment unit can include, but is not limited to, any of the following stages as needed: a de-oiling section, a pH-adjustment section, a softening section, a filtering section, a pre-heating section, a dissolved gas removal section, a combination thereof.

The system 1 further comprises a boiler or evaporator 25 to which wastewater, i.e., produced water from the oilfield well 3, is delivered through the wastewater line 7. In the present description and in the attached claims, the terms “evaporator” and “boiler” can be used as synonyms and both encompass a device in which heat is used to heat and evaporate water.

As will be described below, part of the wastewater is vaporized in the boiler or evaporator 25 and discharged in the environment (arrow S), while the remaining water forms a brine containing a concentrated amount of salts and other chemicals and will be disposed of, for instance transported to a suitable reservoir 27, or re-injected in the ground, through a brine discharge line 28.

The gas turbine sub-system 11 includes a pressure adjusting unit 31, which is fluidly coupled to the gas line 9 and is adapted to adjust the pressure of the natural gas such that the natural gas can be delivered to a combustor 33. In some embodiments the natural gas produced by the oilfield well 3 may have a pressure higher than the pressure required in the combustor 33. In such case the natural gas from the gas line 9 is de-pressurized in the pressure adjusting unit 31. The pressure adjusting unit 31 may include an expansion valve.

In other embodiments, the pressure adjusting unit comprises an expander 34, which can be drivingly coupled to an electric generator, or more generally to an electric machine 35 which can operate in a motor mode or in a generator mode alternatively. The electric machine 35 can be electrically coupled to an electric power distribution grid 37. The natural gas is partly expanded in the expander 34 and the enthalpy drop of the natural gas is used to generate mechanical power available on a shaft connecting the expander 34 to the electric machine 35. Electric power generated by the electric machine operating in the generator mode is fed to the electric power distribution grid 37.

If the natural gas delivered through the gas line 9 has a pressure lower than the pressure required in the combustor 33, the pressure adjusting unit 31 can include a compressor 34 and an electric machine 35 powered by the electric power distribution grid 37 which drives the compressor.

If the pressure of the natural gas in the gas line 9 fluctuates such as to be alternatively higher or lower than the pressure required in the combustor 33, an expander and a compressor can be provided in parallel, or a reversible turbomachine, adapted to operate alternatively as a compressor and as an expander in combination with a reversible electric machine.

In the combustor 33 a mixture of compressed natural gas and compressed air is burned to generate a flow of hot, compressed combustion gas. The combustor 33 is fluidly coupled (at 39) to a power turbine 41.

In some embodiments, air can be fed in the pressure adjusting unit 31 through an air inlet line 32 and can be compressed by a compressor 34 along with the natural gas.

Preferably, air is sucked through an air suction line 42 into a separate compressor 43, which compresses the air at the required combustor pressure and delivers a flow of compressed air to the combustor 33. Natural gas is delivered to the combustor 33 through the pressure adjusting unit 31 at the correct combustor pressure, by either expanding or compressing natural gas from the oilfield well 3.

The compressor 43 can be driven by the power turbine 41, or by a separate driver, such as an electric motor (not shown).

In some embodiments, fuel can be supplied to the combustor 33 through an additional fuel line 45, for instance if insufficient natural gas is supplied by the oilfield well 3. The additional fuel line 45 can be coupled to a gas pipeline, for instance. In some embodiments, the oilfield well 3 can deliver little or no gas, and natural gas required by the gas turbine sub-system 11 can be partly or fully provided by a different source, for instance a different oilfield well, through a gas pipeline 46.

As noted above, since natural gas cannot be discharged in the atmosphere, should the gas turbine sub-system 11 be unavailable, natural gas produced by the oilfield well 3 must be flared in flare 15 and to that end valve 19 is closed and valve 17 is opened. In normal operating conditions, conversely, natural gas from the oilfield well 3 is delivered through open valve 19 towards the gas turbine sub-system 11, while valve 17 is fully closed, or only partially open, for instance if an excess of natural gas is produced by the oilfield well 3.

The discharge of the power turbine 41 is fluidly coupled to the boiler 25, such that exhaust combustion gas flows through the boiler 25 in heat exchange with the produced water from the wastewater line 7. Waste heat contained in the exhaust combustion gas is used to evaporate water and generate steam which, in the embodiment of FIG. 1, is directly discharged in the atmosphere. The exhausted and cooled combustion gas is discharged through a stack 49 or can be processed in a carbon capture system for carbon dioxide removal, prior to be discharged in the environment, thus reducing emissions of greenhouse gases.

The system 1 of FIG. 1 improves the efficiency of wastewater treatment and production of brine therefrom in several respects. Firstly, heat required for partial evaporation of the produced water from the oilfield well 3 is at least partly generated exploiting natural gas from the oilfield well 3. No natural gas is unnecessarily flared.

Secondly, high-temperature combustion gas from the combustor 33 is exploited in a gas turbine cycle to generate useful mechanical power, which can be used as such, or converted into electric power through an electric generator 51, drivingly coupled to the power turbine 41. The electric generator 51 can be electrically coupled to the electric power distribution grid 37. Therefore, the electric power generated by the gas turbine cycle described above can be partly used to run the compressor 34 of the pressure adjusting unit 31, if required.

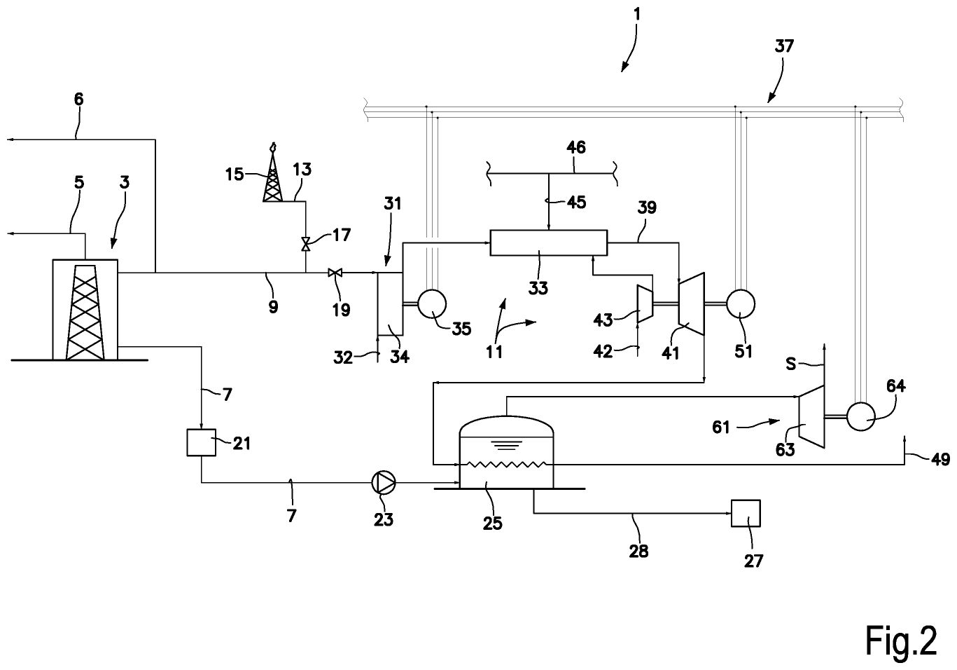

With continuing reference to FIG. 1, a further embodiment of the system according to the invention is schematically shown in FIG. 2. The same reference numbers used in FIG. 1 designate the same parts, which will not be described again.

The main difference between the embodiment of FIG. 1 and the embodiment of FIG. 2 is that the latter further includes a steam turbine sub-system 61. The sub-system 61 comprises an open steam cycle including a steam turbine 63, which is fluidly coupled to the boiler 25. Compressed steam from the boiler 25 expands in the steam turbine 63 and the exhaust steam S is then released in the atmosphere. Mechanical power generated by the steam turbine 63 can be converted into electric power by an electric generator 64, which can be electrically coupled to the electric power distribution grid 37.

In the embodiment of FIG. 2, additional useful power is therefore generated by the open bottom steam cycle including the steam turbine 63, further improving the energy efficiency of the system 1.

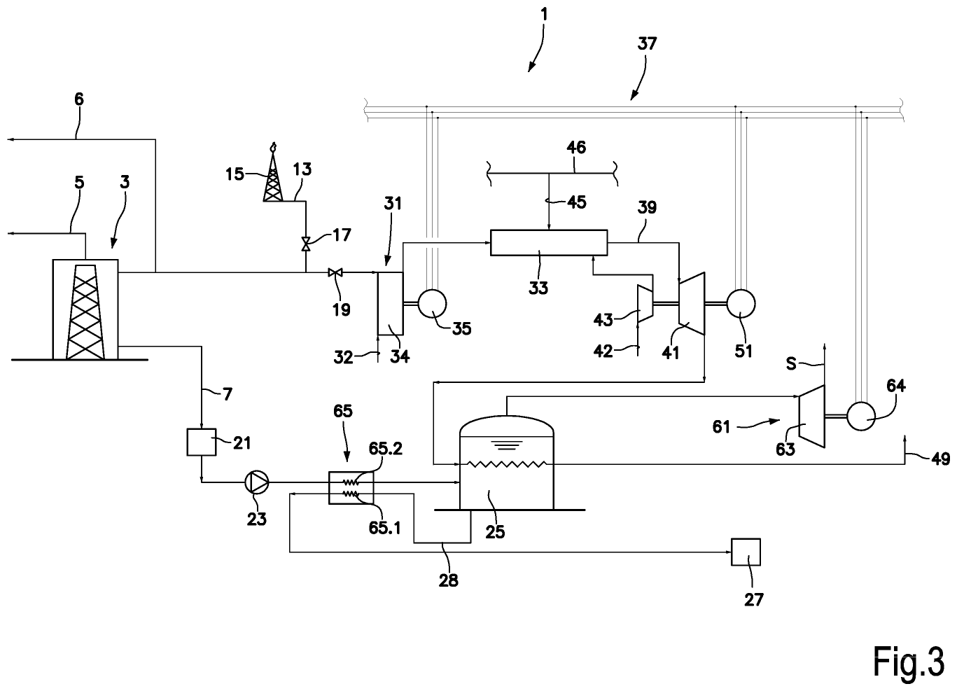

With continuing reference to FIGS. 1 and 2, a yet further embodiment of the system according to the present disclosure is disclosed in FIG. 3. The same reference numbers designate the same or equivalent parts already described with reference to FIGS. 1 and 2, and will not be described again.

The embodiment of FIG. 3 differs from the embodiment of FIG. 2 mainly in that heat is recovered from the brine discharged from the boiler 25 and used to pre-heat the wastewater before feeding to the boiler 25. Heat is recovered from the brine flowing in the brine discharge line 28 through a heat exchanger 65. The brine flows through the hot side 65.1 of the heat exchanger 65, in heat exchange with wastewater flowing through the wastewater line 7, which includes the cold side 65.2 of the heat exchanger 65.

A heat exchanger 65 for heat recovery from the brine can be used also in an embodiment according to FIG. 1.

Embodiments disclosed herein provide for a more efficient approach to concentration and reduction of the volume of the produced water from oilfield wells, as high-temperature heat from the combustion of natural gas from the oilfield well is cascaded to generate electric power through one or two thermodynamic cycles.

In all embodiments, steam is generated by heat exchange with a combustion gas that has been previously expanded in a gas turbine to convert high-temperature heat into mechanical power. The expanded combustion gas entering the boiler may have, for instance, a temperature of around 400° C. or below which is lower than the temperature usually adopted in boilers of the current art.

A lower evaporation temperature compared to current evaporators may results in reduced scaling of the boiler In FIGS. 1 to 3 the pressure adjusting unit comprises a turbomachine drivingly coupled to an electric machine. The turbomachine can be a compressor, an expander or a reversible turbomachine adapted to operate as a compressor or as an expander, depending upon the pressure of the natural gas from the oilfield. The electric machine can operate accordingly in a motor mode or in a generator mode.

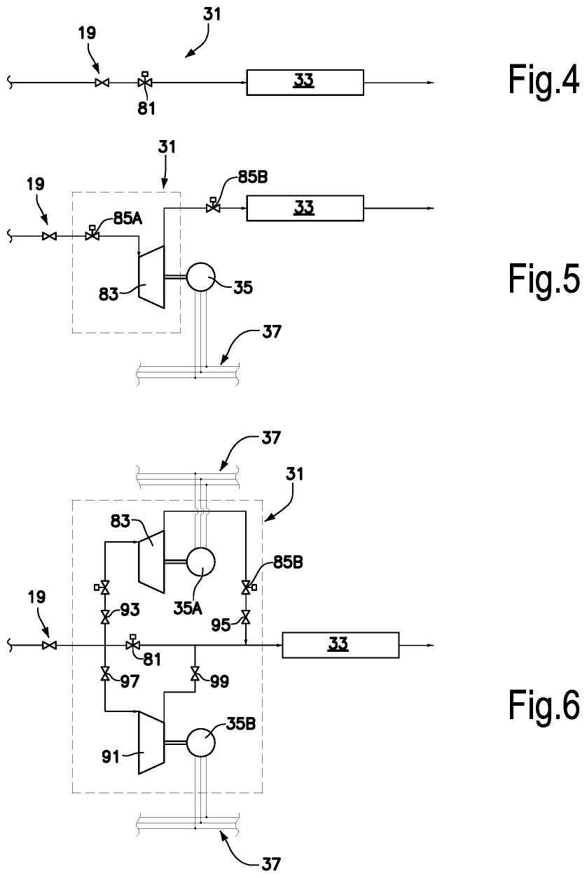

In other embodiments, where natural gas at a pressure higher than the combustor pressure is expected, the pressure adjusting unit 31 can include a simple throttling or laminating valve, which may be adjustable to process natural gas at variable pressure. A schematic embodiment of a pressure adjusting unit 31 including a simple pressure adjusting valve 81 is shown in FIG. 4.

In alternative embodiments, the pressure adjusting unit may include a pressure adjusting valve, such as a throttling valve or a laminating valve in combination with an expander. The pressure adjusting valve can be arranged upstream of an expander or downstream of an expander with respect to the direction of flow of the natural gas. FIG. 5 illustrates schematically a pressure adjusting unit 31 comprising an expander 83 drivingly coupled to an electric generator 35 electrically connected to an electric power distribution grid 37. A pressure adjusting valve 85A is arranged upstream of the expander 83. Alternatively, or in combination, a pressure adjusting valve 85B can be arranged downstream of the expander 83.

In yet further embodiments, the pressure adjusting unit 31 can include a more complex arrangement of devices, adapted to increase or decrease the pressure of the natural gas of the oilfield well, according to needs. FIG. 6 illustrates a pressure adjusting valve 81 in parallel to an expander 83 and a compressor 91. The expander 83 is drivingly coupled to an electric generator 35A, which is in turn electrically coupled to an electric power distribution grid 37. The compressor 91 is drivingly coupled to an electric motor 35B, which is in turn electrically connected to the electric power distribution grid 37. Closure valves can be provided at the intake and outlet sides of the expander 83 and at suction side and delivery side of the compressor 91. In the drawing, valves 93, 95 97, 99 are provided. In some embodiment, valve 95 and 99 can be omitted. In addition or alternatively, to one or both valves 93, 95, respective pressure adjusting valve(s) 85A and 85B can be foreseen to adjust the pressure at the intake of the expander 83 and/or at the outlet of the expander 83, to adjust the pressure drop across the expander.

The pressure adjusting unit 31 of FIG. 6 can operate in different modes. In one operating mode the valves 93, 95, 97, 99 can be closed and the pressure adjusting valve 81 adjusts the pressure of the natural gas of the oilfield well at the requested combustor pressure. Alternatively, the natural gas can be expanded through the expander 83 keeping valves 93, 95 open and valves 97, 99, 81 closed. If required, valve(s) 85A, 85B or one of them can be used to adjust the intake or outlet pressure of the expander, if needed. If the pressure of the natural gas of the oilfield well is below the combustor pressure, valves 93, 95, 81 can be closed and valves 97, 99 can be open to pressurize the natural gas at the required combustor pressure.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A wastewater treatment system for treating wastewater from an oilfield well; the system comprising:
an oilfield well;
a combustor adapted to bum a fuel and generate pressurized combustion gas therewith;
wherein the combustor is adapted to receive natural gas of an oilfield through a gas line;
a pressure adjusting device, adapted to receive natural gas of the oilfield and to adapt a pressure thereof to a combustion pressure in the combustor;
a gas turbine adapted to expand the pressurized combustion gas and generate mechanical power therewith;
a boiler adapted to receive expanded combustion gas from the gas turbine and fluidly coupled to a wastewater line which delivers wastewater from the oilfield well; wherein in use heat from the combustion gas generates steam from the wastewater; and
a brine discharge line from the boiler.

2. The system of claim 1, wherein the pressure adjusting device comprises a turbomachine drivingly coupled to an electric machine, the turbomachine operating as a compressor or as an expander and the electric machine operating in a motor mode or in a generator mode.

3. The system of claim 1, further comprising a first electric generator drivingly coupled to the gas turbine and adapted to convert mechanical power generated by the gas turbine into electric power.

4. The system of claim 1, further comprising a steam turbine adapted to receive steam from the boiler and expand said steam to generate mechanical power.

5. The system of claim 4, further comprising a second electric generator drivingly coupled to the steam turbine and adapted to convert mechanical power generated by the steam turbine into electric power.

6. The system of claim 1, further comprising a wastewater pre-treatment unit.

7. The system of claim 6, wherein the wastewater pre-treatment unit comprises at least one of: a de-oiling section, a pH-adjustment section, a softening section, a filtering section, a pre-heating section, a dissolved gas removal section, a combination thereof.

8. The system of claim 1, further comprising a heat exchanger with a hot side and a cold side; wherein the brine discharge line flows through the hot side of the heat exchanger, and wherein the wastewater line flows through the cold side of the heat exchanger, such that heat from the brine is recovered by the wastewater.

9. A method for treating wastewater from an oilfield well, the method comprising the following steps:
delivering natural gas of the oilfield to a combustor;
adapting a pressure of the natural gas of the oilfield to a combustor pressure;
mixing natural gas of the oilfield well and compressed air and bum a resulting air-gas mixture in the combustor and generate pressurized combustion gas;
expanding the combustion gas in a gas turbine and producing mechanical power therewith; and
producing steam and a brine flow from said wastewater by evaporating wastewater using waste heat from the expanded combustion gas.

10. The method of claim 9, wherein the step of adapting the pressure of the natural gas comprises the step of compressing the natural gas or expanding the natural gas.

11. The method of claim 10, wherein the step of compressing the natural gas or the step of expanding the natural gas includes the step of processing the natural gas in a turbomachine drivingly coupled to an electric machine; wherein the electric machine provides power to drive the turbomachine when the natural gas is compressed and the electric machine generates power when the natural gas is expanded.

12. The method of claim 9, further comprising the step of discharging the steam in the environment.

13. The method of claim 9, further comprising the step of converting mechanical power generated by the gas turbine into electric power.

14. The method of claim 9, further comprising the step of expanding the steam in a steam turbine and generating mechanical power therewith.

15. The method of claim 14, further comprising the step of converting the mechanical power generated by the steam turbine into electric power.

16. The method of claim 9, further comprising the step of pre-heating the wastewater by heat exchange with the brine discharged from the boiler.

17. A wastewater treatment system for treating wastewater from an oilfield well; the system comprising:
a combustor adapted to bum a fuel and generate pressurized combustion gas therewith;
a gas turbine adapted to expand the pressurized combustion gas and generate mechanical power therewith;
a boiler adapted to receive expanded combustion gas from the gas turbine and fluidly coupled to a wastewater line; wherein in use heat from the combustion gas generates steam from the wastewater;
a brine discharge line from the boiler; and
a steam turbine adapted to receive steam from the boiler, expand said steam to generate mechanical power and release spent steam in the atmosphere.

18. The system of claim 17, further comprising a first electric generator drivingly coupled to the gas turbine and adapted to convert mechanical power generated by the gas turbine into electric power.

19. The system of claim 17, further comprising a second electric generator drivingly coupled to the steam turbine and adapted to convert mechanical power generated by the steam turbine into electric power.

20. The system of claim 17, further comprising a wastewater pre-treatment unit.

21. The system of claim 20, wherein the wastewater pre-treatment unit comprises at least one of: a de-oiling section, a pH-adjustment section, a softening section, a filtering section, a pre-heating section, a dissolved gas removal section, a combination thereof.

22. The system of claim 17, further comprising a heat exchanger with a hot side and a cold side; wherein the brine discharge line flows through the hot side of the heat exchanger, and wherein the wastewater line flows through the cold side of the heat exchanger, such that heat from the brine is recovered by the wastewater.

23. A method for treating wastewater from an oilfield well, the method comprising the following steps:
generating pressurized combustion gas in a combustor;
expanding the combustion gas in a gas turbine and producing mechanical power therewith;
producing steam and a brine flow from the wastewater by evaporating wastewater using waste heat from the expanded combustion gas; and
expanding the steam in a steam turbine and releasing spent steam in the atmosphere.

24. The method of claim 23, further comprising the step of converting mechanical power generated by the gas turbine into electric power.

25. The method of claim 23, further comprising the step of converting the mechanical power generated by the steam turbine into electric power.

26. The method of claim 23, further comprising the step of pre-heating the wastewater by heat exchange with the brine discharged from the boiler.
